(19) United States
(12) Patent Application Publication
(10) Pub. No.: US 2011/0225793 A1
(43) Pub. Date: Sep. 22, 2011

(54) Ice Toggle

(76) Inventor: William Billings Daniels, III, Gex (FR)

(21) Appl. No.: 13/118,247

(22) Filed: May 27, 2011

(51) Int. Cl. A63B 29/02; B23P 11/00

(52) U.S. Cl. 29/428; 248/231.9

(57) ABSTRACT

The present invention is direct to an ice toggle for establishing a removable anchor in a body of ice during ice climbing activities. One embodiment of the ice toggle is comprised of a flexible stem, a toggle that is pivotally attached to one end of the stem, a trigger mechanism for rotating the toggle relative to the flexible stem, and an engagement surface in the form of a loop that is associated with the other end of the flexible stem and capable of receiving a carabiner or runner.

### FIELD OF THE INVENTION

The present invention relates to an apparatus for use in establishing a removable anchor in a body of ice during ice climbing activities.

### BACKGROUND OF THE INVENTION

Ice climbing is a sport that typically involves ascending a high angle mass of ice, typically in the form of a frozen waterfall or face of a glacial structure. Special tools are required for ice climbing. To facilitate the climber's movement over high angle ice surfaces, the climber typically uses two ice axes, one associated with each hand of the climber, and crampons that are attached to the climber's boots. Most ice climbers also utilize equipment that is designed to limit the length of the climber's fall in the event that the climber should become dislodged from the ice surface. This equipment includes anchors that can be placed in or attached to the ice, a rope, and carabiners for attaching the rope to the anchors. One type of anchor is an “ice piton” that includes a shaft and hangar that is attached to one end of the shaft and has an opening for receiving a carabiner that is also used to engage a rope. Generally, for the climber to feel that the ice piton is unlikely to become dislodged from the ice under a loading condition (e.g., such as a fall), the climber wants to be able to drive the ice piton into ice of sufficient depth that the shaft can be driven into the ice until the hangar is immediately adjacent the surface of the ice. Further, the climber wants to feel that the shaft is engaging ice of a relatively dense consistency.

Ice pitons have evolved of the years. Presently, the ice pitons that are most commonly used are ice screws. The typical ice screw is comprised of a hollow shaft with a thread that is associated with the external surface of the shaft, teeth associated with an open end of the shaft, and a hangar structure associated with the other end of the shaft. In operation, the climber places the teeth of the screw against an ice surface and then applies a twisting force to the hangar end of the screw to drill the screw into the ice. Removal of the screw involves applying a reverse twisting force to the hangar end of the screw. Due to the hollow nature of the screw, removal of the screw leaves a hole in the ice.

### SUMMARY OF THE INVENTION

Generally, in ice climbing, the ice that is being climbed is relatively opaque. Consequently, when the climber is placing an ice piton into the ice, the climber typically is not able to visually inspect the contact between the portion of the piton that has been driven into the ice and the ice or the lack of ice immediately adjacent to the driven portion of the ice piton. However, the climber typically is able to sense, during the driving of the piton into the ice, whether the piton is passing through an air pocket, rotten ice, or snow. Typically, the screwing or hammering of the piton becomes much easier when an air pocket, rotten ice, or snow is encountered than when the piton is being driven into ice having a relatively dense consistency. Sensing that a piton being driven into ice is passing through an air pocket or engaging rotten ice or snow is sometimes referred to as “hitting air.” In many instances, the ability of an ice piton that is “hitting air” to adequately perform in the event of a fall by the climber is substantially compromised.

An ice climber that is driving an ice piton into ice and “hitting air,” has several options. If the climber feels that the ice piton that is “hitting air” is of little value in the event of a fall, the climb may attempt to place another ice piton in a nearby but different location and hope that the ice is better in that location. Under this option, the climber is required to expend additional energy in driving a second anchor into the ice without any assurance that the second ice piton also will not “hit air.” Another option, if the climber feels that the portion of the ice piton that was driven into the ice before “hitting air” provides a meaningful amount of protection, the climber can cinch a runner (a loop of rope or webbing) around the portion of the shaft of the ice piton that is adjacent to the ice surface. A carabiner can then be attached to the runner. The use of the runner reduces the lever arm and chances of dislodging the ice piton in the event of a fall relative to the use of carabiner to engage the hangar, which is separated from the surface of the ice. One other option available to the climber is to continue climbing and endeavor to place an ice piton or other form of protection higher up on the climb. This option, however, increases the distance that the climber may fall and the risk of injury in the event of a fall. Nonetheless, ice climbing is a very strenuous sport and, in some cases, the risk of proceeding up the climb versus the expenditure of energy in trying to place an anchor of potentially marginal value may be acceptable.

The present invention provides the ice climber with another option when an ice piton that the climber is trying to place in the ice “hits air.” To elaborate, the present invention provides an ice toggle that includes a flexible stem, a toggle pivotally attached to the stem, a trigger mechanism for rotating the toggle relative to the flexible stem, and a surface associated with the stem that defines a hole or loop for receiving a carabiner or runner. The ice toggle can be inserted through a hole established in the ice by an ice piton or a naturally occurring opening in the ice. Assuming that a hole produced by an ice piton (typically, 20 mm in diameter) is present, the trigger mechanism is used to cause the toggle to rotate relative to the stem such that the longitudinal axis of the toggle is brought closer into alignment with the longitudinal axis of the stem to allow the toggle and a portion of the stem adjacent to the toggle to be inserted into the hole. The toggle and portion of the stem are inserted into the hole. This insertion continues at least until the point at which the toggle is in the air pocket, rotten ice, or snow and can be rotated so that the longitudinal axis of the toggle become more transverse to the longitudinal axis of the stem. The climber can then pull the stem outward (i.e., away from the ice surface) to “set” the toggle against the interior ice surface associated with the air pocket, rotten ice pocket or snow. A carabiner or runner is passed through the hole or loop associated with the stem.

In one embodiment, the ice toggle includes a toggle with a U-shaped cross-section that defines a cavity. The ice toggle further includes a trigger mechanism with a cable that is attached to the toggle. Actuation of the trigger causes the toggle to rotate such that a portion of the flexible stem and a portion of the cable mechanism are located within the cavity defined by the toggle. When the toggle is in this position, the longitudinal axis of the toggle is substantially aligned with the longitudinal axis of the stem.

Yet a further embodiment includes a trigger mechanism that includes a spring. The spring cooperates with the cable so that when the spring is in an uncompressed state, the cable of the trigger mechanism positions the toggle such that the longitudinal axis of the toggle is substantially perpendicular to the longitudinal axis of the stem. In contrast, when the spring is in a compressed state, the spring cooperates with the cable to cause the toggle to rotate to a position at which the longitudinal axis of the toggle is more aligned with the longitudinal axis of the stem.

### BRIEF DESCRIPTION OF THE DRAWINGS

FIG. 1 is a plan view of an embodiment of an ice toggle with the toggle substantially perpendicular to the stem;

FIG. 2 is a side view of the embodiment of the ice toggle shown in FIG. 1 with the toggle substantially in alignment with the stem;

FIGS. 3-6 are perspective views of the embodiment of the ice toggle shown in FIG. 1;

FIG. 7 is an exploded view of the embodiment of the ice toggle shown in FIG. 1; and

FIGS. 8A-8C illustrate the use of the embodiment of the ice toggle shown in FIG. 1 to establish an anchor in a mass of ice.

### DETAILED DESCRIPTION

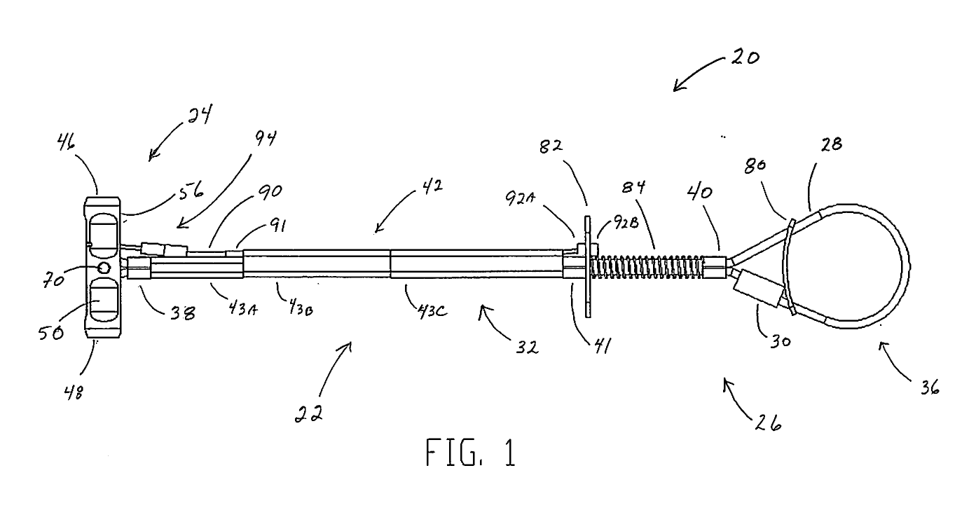

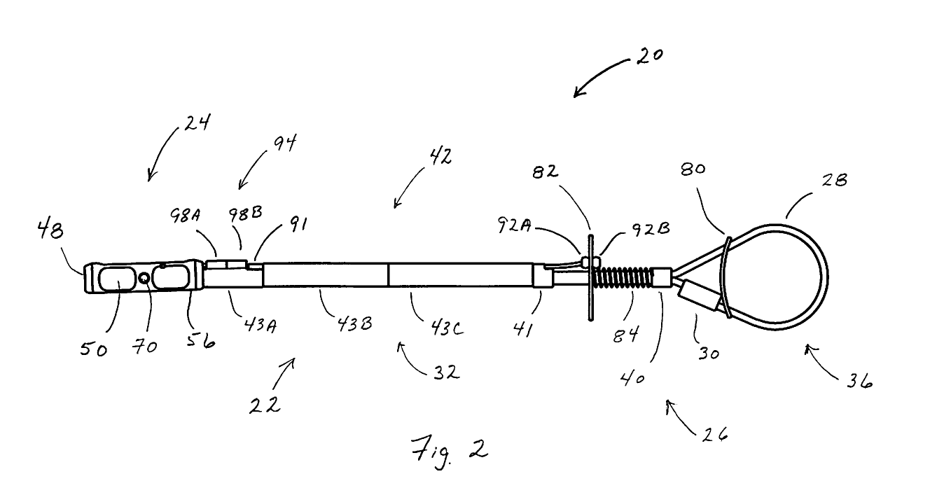

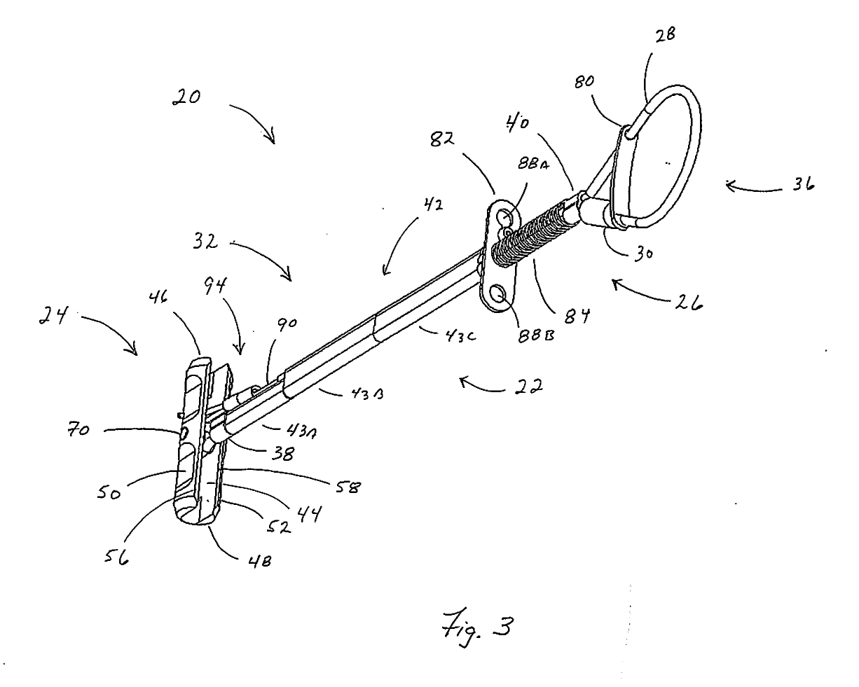

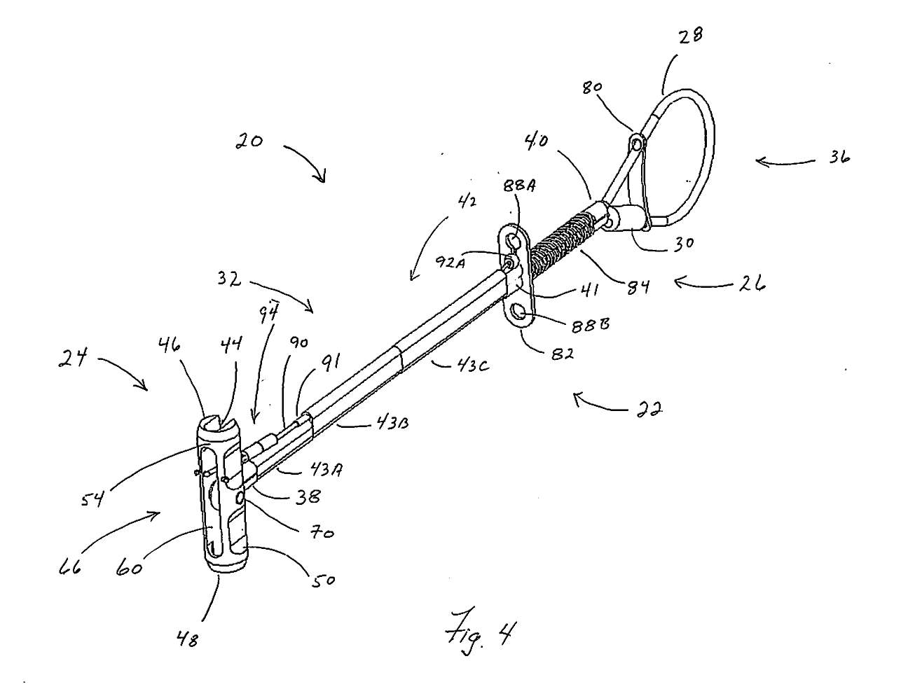

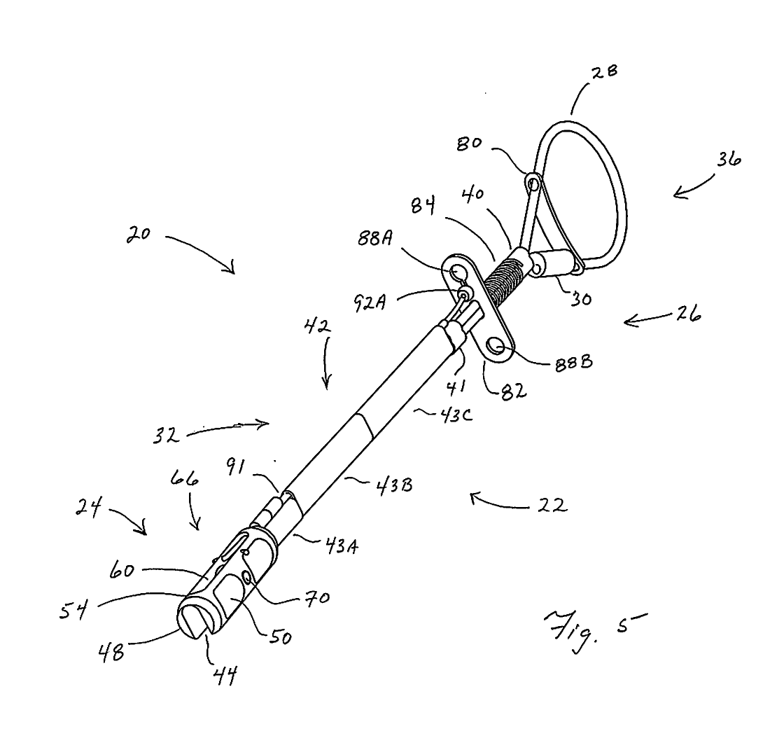

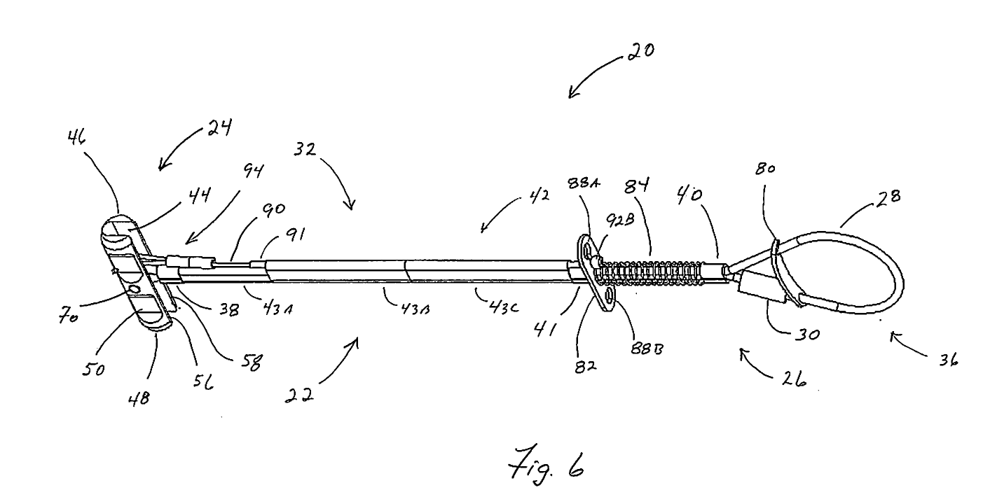

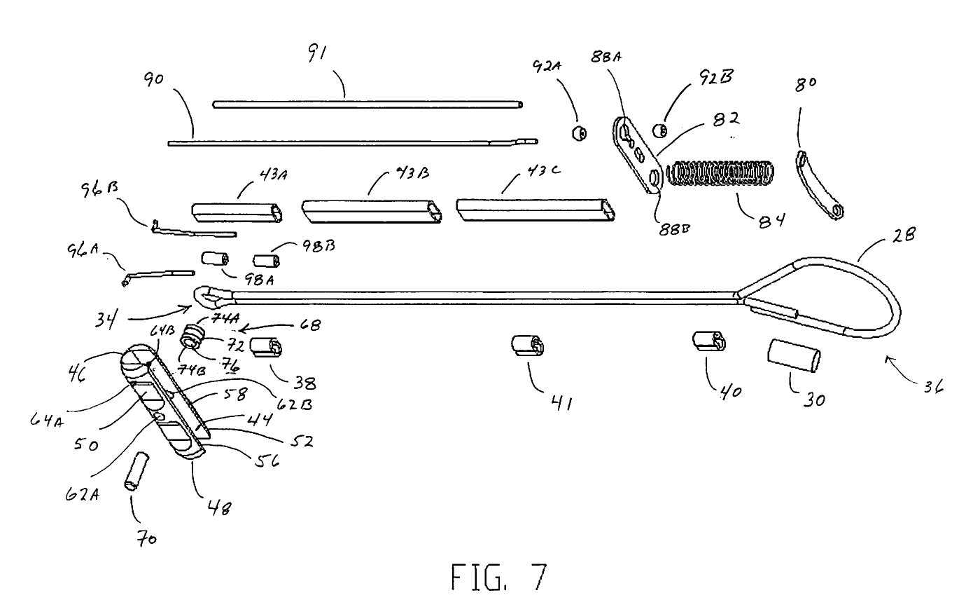

With reference to FIGS. 1-7, an embodiment of an ice toggle 20 that can be used to establish an anchor in a mass of ice is described. Generally, the ice toggle 20 is comprised of a flexible stem 22, a toggle 24 that is pivotally attached to the stem 22, and a trigger mechanism 26 for use in causing the toggle to rotate relative to the stem.

The stem 22 is comprised of a wire cable 28 with ends that are swaged together with a sleeve 30. The stem 22 if further comprised of a sleeve structure 32 that hold two portions of the cable 28 in close proximity to one another, forms a third portion of the cable 28 into a first loop 34, and forms a fourth portion of the cable 28 into a second loop 36. The sleeve structure 32 is comprised of a first ferrule 38 that is located adjacent to the first loop 34, a second ferrule 40 located adjacent to the second loop 36, a third ferrule 41 located between the first ferrule 38 and the second ferrule 40, and a flexible plastic sleeve structure 42 that extends between the first ferrule 38 and the third ferrule 41. The flexible plastic sleeve structure 42 is comprised of three, separate plastic sleeves 43A-43C that are each a different color. This color coding provides markers that allow the climber to assess the depth of the ice between the toggle 24 and the exterior surface of the ice when the toggle 20 is being used as an anchor. It should be appreciated that other forms of flexible stem are feasible. For instance, a flexible stem can be realized using a wire cable with the ends of the cable each swaged to intermediate portions of the cable so as to form first and second loops but with a single strand of cable extending between the loops, rather than two strands of cable extending between the loops.

Generally, the toggle 24 is an open-ended body that has U-shaped cross-section and defines a cavity 44 capable of accommodating a portion of the stem 22 and a portion of the trigger mechanism 26. The toggle 24 extends from a first end 46 to a second end 48. Further, the toggle 24 has a first side 50, a second side 52 that is separated from and substantially parallel to the first side 50, and a third side 54 that connects the first and second sides to one another. Respectively associated with the first and second sides 50, 52 are ice engaging edges 56, 58. The third side 54 defines a hole 60 that reduces the weight of toggle and facilitates removal of ice or snow from the cavity 44. The first and second sides 50, 52 also respectively define holes 62A, 62B that are used to receive a pin that is used in establishing a pivot connection between the toggle 24 and the stem 22. Holes 64A, 64B are used to receive a pin that is used to establish a connection between the toggle 24 and the trigger mechanism 26. The toggle 24 is made by milling an ingot of metal rod having a circular cross-section. However, other methods of making the toggle known to those skilled in the art are also feasible. Typically, the metal employed is an aircraft-grade aluminum or chrome-moly steel. However, other suitable metals or alloys can be employed. In the illustrated embodiment, the toggle 24 is approximately 5.8 mm in length and 16 mm in diameter. It should be appreciated that a toggle with a different cross-sectional shape can be employed. Further, a toggle with a different length is feasible. It should, however, be noted that increasing the length of the toggle requires a correspondingly larger cavity in the ice that will allow the toggle to rotate and engage the interior surface of the cavity. Additionally, a toggle with a different maximum cross-sectional dimension can be employed to accommodate different size holes in the ice.

A pivot connector 66 is used to establish a connection between the stem 22 and the toggle 24 that allows the toggle 24 and the stem to rotate relative to one another. The pivot connector 66 is comprised of a cylinder 68 and a pin 70. The cylinder 68 has an outer surface 72, first and second end surfaces 74A, 74B, and defines a hole 76 that extends between the first and second end surfaces 74A, 74B and is capable of accommodating the pin 70. The outer surface 72 has a groove that forms a seat for receiving the first loop 34, thereby establishing a connection between the cylinder 68 and the flexible stem 22. The distance between the first and second end surfaces 74A, 74B is slightly less than the distance between the interior surfaces of the first and second sides 50, 52 of the toggle 24. The pin 70 connects the toggle 24 to the cylinder 68. More specifically, the pin 70 is accommodated in the holes 62A, 62B respectively defined by the first and second sides 50, 52 of the toggle 24 to establish an interference fit between the pin 70 and the toggle 24. Further, pin 70 is accommodated in the hole 76 defined by the cylinder 68 to establish an interference fit between the pin 70 and the cylinder 68. It should be appreciated that other structures can be used to establish a rotational connection between the stem 22 and the toggle 24. For example, a cylinder can be employed that facilitates the brazing or welding of the cable to the cylinder, thereby eliminating the need for the first loop 34.

The trigger mechanism 26 is comprised of a thumb bar 80, a finger bar 82, a spring 84 that extends between the finger bar 82 and the second ferrule 40, a cable assembly 86 that connects the toggle 24 and the finger bar 82. The finger bar 82 defines a pair of holes 88A, 88B that are provided so that a hook of similar structure can be used to engage the finger bar 82 when the finger bar 82 can not be readily grasped. The cable assembly 86 is comprised of a cable 90, a cable housing 91 that houses most of the cable 90 and is substantially located within the plastic sleeves 43B, 43C, a dumbbell connector comprised of dumbbells 92A, 92B attached to one end of the cable 90, and a trigger connector 94 attached to the other end of the cable 90. The dumbbell connectors 92A, 92B cooperate with the portion of the finger bar 82 that defines the hole 88A such that the cable 90 can be readily attached to and detached from the finger bar 82. The trigger connector 94 is comprised of pins 96A, 96B that are attached to the cable 90 using ferrules 98A, 98B. The pins 96A, 96B also engage the toggle 24. More specifically, the pins 96A, 96B are respectively accommodated in the holes 64A, 64B respectively defined by the first and second sides 50, 52 of the toggle 24. If the cable 90 should be cut or frayed and require replacement, the pins 96A, 96B can be removed from the holes 64A, 64B, the cable 90 severed at a point between the ferrule 98B and the plastic sleeve 43B, and the dumbbell connector 92 disengaged from the finger bar 82. At this point, the cable 90 can be removed. A new cable with an attached dumbbell connector can then be attached to the finger bar 82, new pins inserted into the holes 64A, 64B, and the new pins connected to the new cable with new ferrules. It should be appreciated that other trigger mechanisms that facilitate the rotation of the toggle relative to the stem for inserting the toggle through a hole in a body of ice, anchoring of the toggle against the interior surface of an ice cavity, and subsequently extracting the toggle through the hole in the body of ice are feasible.

The holes 64A, 64B that receive the pins 96A, 96B of the trigger connector 94 are positioned between the holes 62A, 62B that receive the pin 70 and the first end 46 of the toggle 24. Further, the holes 64A, 64B are positioned between the pin 70 and the third side 54 of the toggle 24. This positioning of the holes 64A, 64B is such that, when the trigger mechanism is actuated, the toggle 24 can be rotated such that the longitudinal axis of the toggle 24 is aligned or substantially parallel to the longitudinal axis of the flexible stem 22.

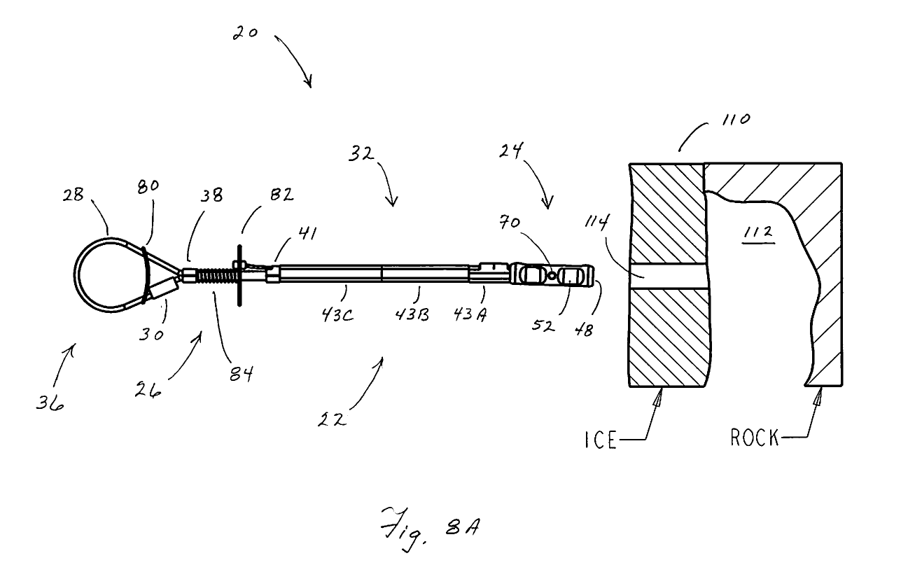

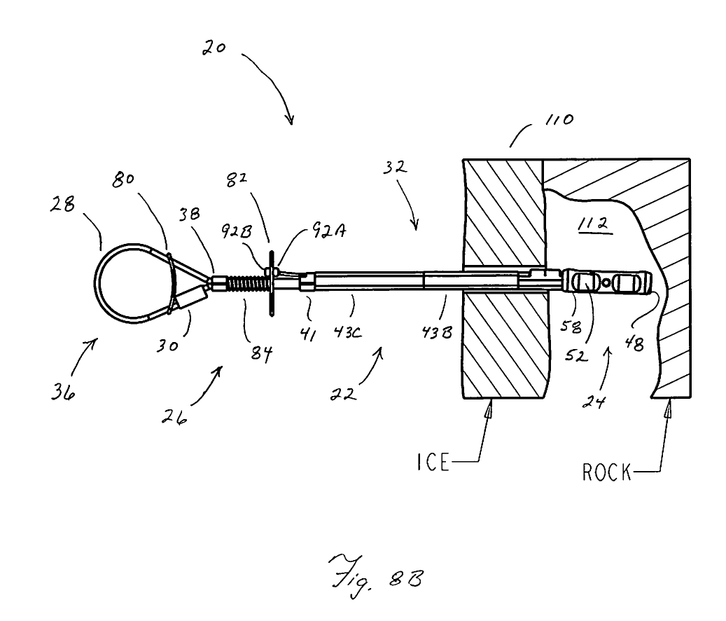

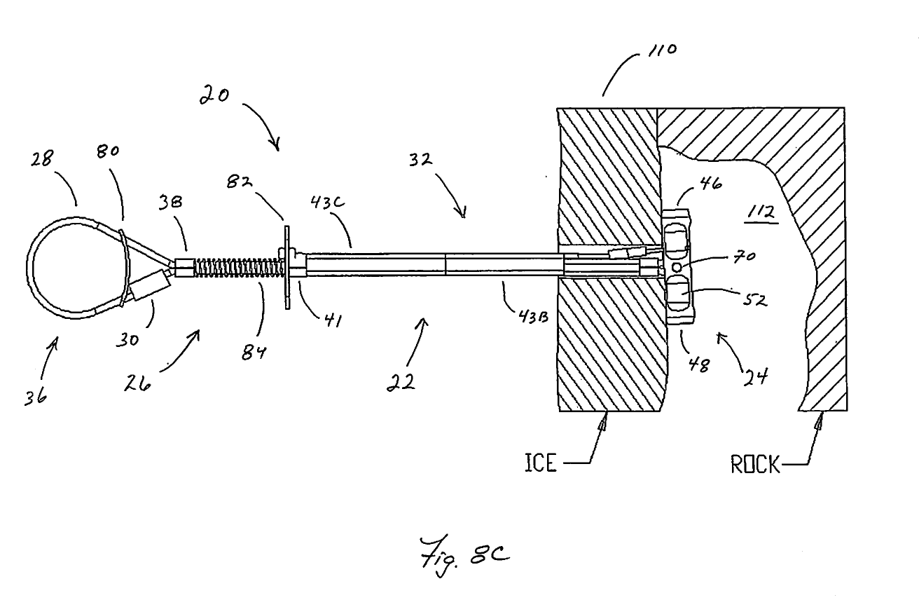

With reference to FIGS. 8A-8C, an example of the method of using the ice toggle 24 is described. Initially, it is assumed that a climber has placed an ice piton in a body of ice 110, concluded that ice piton “hit air” 112 during the placement, decided to remove the ice piton from the body of ice, thereby leaving a hole 114 in the body of ice, and has decided to place the ice toggle 20 in the body of ice 110. Placement of the ice toggle 20 in the body of ice 110 initially involves actuating the trigger mechanism 26 so that the toggle 24 is rotated relative to the stem such that the toggle 24 and portion of the stem adjacent to the stem can be inserted into the hole 114 in the ice. The climber will typically actuate the trigger mechanism 26 by placing their thumb (typically in a glove) on the thumb bar 80, forefinger on one side of the finger bar 82, and middle finger on the other side of the finger bar 82 and then drawing the thumb and finger towards one another. The toggle 24 and a portion of the stem 24 are then inserted into the hole 114 in the ice. Typically, the climber can remove their forefinger and middle finger from the finger bar 82 at this point because the ice defining the hole 114 in the ice keeps the toggle sufficiently aligned to allow the continued insertion of the toggle 24. Once the toggle 24 is no longer constrained by the ice and in the air pocket, rotten ice, or snow, the spring 84 applies a force to the toggle 24 via the cable 90 that causes the toggle 24 to rotate such that the longitudinal axis of the toggle 24 is substantially perpendicular to the longitudinal axis of the stem 22. The climber can then pull outward on the stem 22 so that the ice engaging edges 56, 58 of the toggle can engage the ice adjacent to the interior end of the hole 114, thereby establishing the ice toggle 20 as an anchor in the ice 110.

Removal of the ice toggle 20 established in the ice 110 involves pushing the stem inwards a sufficient distance so that the trigger mechanism 26 can be actuated to cause the toggle 24 to rotate such that the toggle 24 can pass through the hole 114.

The foregoing description of the invention is intended to explain the best mode known of practicing the invention and to enable others skilled in the art to utilize the invention in various embodiments and with the various modifications required by their particular applications or uses of the invention.

What is claimed is:

1. An ice toggle comprising:
a flexible stem extending from a first end to a second end;
a surface associated with the second end of the stem and defining a hole capable of receiving a carabiner;
a toggle pivotally attached to the first end of the flexible stem; and
a trigger mechanism capable of being actuated by a user to cause the toggle to pivot from a first position to a second position in which the angle between the longitudinal axis of the toggle and the flexible stem is less than in the first position and that facilitates the insertion of the toggle and a portion of the stem through an opening in a body of ice.

2. An ice toggle, as claimed in claim 1, wherein:
the flexible stem comprises a metal cable.

3. An ice toggle, as claimed in claim 1, wherein:
the toggle has a U-shaped lateral cross-section.

4. An ice toggle, as claimed in claim 1, wherein:
the toggle has an open end.

5. An ice toggle, as claimed in claim 1, wherein:
the toggle has two open ends.

6. An ice toggle, as claimed in claim 1, wherein:
the toggle has a first side, a second side that is spaced from the first side, a third side that connects the first side and the second side such that the first, second and third sides have a U-shaped lateral cross-section.

7. An ice toggle, as claimed in claim 6, wherein:
the first, second and third sides define a cavity for receiving a portion of the flexible stem when the toggle is in the second position.

8. An ice toggle, as claimed in claim 6, wherein:
the first, second, and third sides define an open end.

9. An ice toggle, as claimed in claim 6, wherein:
the third side defines an opening.

10. An ice toggle, as claimed in claim 1, wherein:
the toggle extends from a first terminal end to a second terminal end and from an upper surface to a lower surface;
a pivot pin that facilitates the connection of the toggle to the flexible stem is located at a toggle pivot location situated mid-way between the first and second terminal ends.

11. An ice toggle, as claimed in claim 10, wherein:
the trigger comprises a cable with one end attached to the toggle at a cable location that is between the toggle pivot location and one of the first and second terminal ends of the toggle.

12. An ice toggle, as claimed in claim 11, wherein:
the cable location is between the toggle pivot location and the upper surface of the toggle.

13. An ice toggle, as claimed in claim 1, wherein:
a first color is associated with a first portion of the stem and a second color that is different than the first color is associated with a second portion of the stem that is different than the first portion of the stem, the first and second colors allowing a climber to assess the depth of the ice when the ice toggle is being used as an anchor in a body of ice.

14. A method for establishing a removal anchor behind a body of ice, the method comprising:
providing an ice toggle comprising:
a flexible stem extending from a first end to a second end;
a surface associated with the second end of the stem and defining a hole capable of receiving a carabiner;
a toggle pivotally attached to the first end of the flexible stem; and
a trigger mechanism capable of being actuated by a user to cause the toggle to pivot from a first position to a second position in which the angle between the longitudinal axis of the toggle and the flexible stem is less than in the first position and that facilitates the insertion of the toggle and a portion of the stem through an opening in a body of ice;
actuating the trigger mechanism to place the toggle in the second position;
inserting, following the step of actuating, the toggle and a portion of the flexible stem through a hole in a body of ice; and
releasing, following the step of actuating, the trigger mechanism to allow the toggle to be moved toward the first position so that the toggle can engage an interior surface of the body of ice.

15. A method, as claimed in claim 14, further comprising:
actuating, following the step of releasing, the trigger mechanism to place the toggle in the second position to facilitate extraction of the toggle through the opening in the body of ice.
